(19) United States
(12) Patent Application Publication
(10) Pub. No.: US 2025/0077210 A1
(43) Pub. Date: Mar. 6, 2025

(54) PROGRAMMABLE LOGIC CONTROLLER, TERMINAL DEVICE, PROGRAM MANAGEMENT SYSTEM, PROGRAM MANAGEMENT METHOD, AND RECORDING MEDIUM

(71) Applicant: Mitsubishi Electric Corporation, Tokyo (JP)

(72) Inventor: Weihau LEE, Tokyo (JP)

(73) Assignee: Mitsubishi Electric Corporation, Tokyo (JP)

(21) Appl. No.: 18/038,209

(22) PCT Filed: Jun. 8, 2021
(86) PCT No.: PCT/JP2021/021779

§ 371 Date: May 23, 2023

(51) Int. Cl. G06F 8/65

(52) U.S. Cl. CPC G06F 8/65

(57) ABSTRACT

A programmable logic controller or PLC (10) includes a program storage (120) to store a program executable on the PLC (10), an updater (110) to update the program stored in the program storage (120), and a version manager (140) to perform version management of the program stored in the program storage (120). The version manager (140) performs version management of the program stored in the program storage (120) based on a time at which the program is updated by the updater (110) and identification information for individually identifying the program to undergo version management.

### TECHNICAL FIELD

The present disclosure relates to a programmable logic controller, a terminal device, a program management system, a program management method, and a program.

### BACKGROUND ART

Any trouble associated with a programmable logic controller (PLC) may undergo troubleshooting performed by analyzing the log being recorded by the PLC and the program being executed by the PLC.

As a technique for the above, Patent Literature 1 describes a PLC that stores a program currently being executed and data acquired by executing the program when a particular event occurs during the operation of the PLC.

### CITATION LIST

### Patent Literature

Patent Literature 1: Unexamined Japanese Patent Application Publication No. 2020-013527

### SUMMARY OF INVENTION

### Technical Problem

Troubleshooting is performed based on determination of a point of change in the program stored in the PLC. For example, a bug in the program may cause trouble. To identify the bug, the point of change at which the bug enters the program is to be determined.

However, the technique described in Patent Literature 1 cannot identify changes in the program before the particular event and thus cannot determine the point of change in the program.

One solution to this issue may be to install a typical version management system in a terminal device used to develop a program executable on the PLC and cause the version management system to perform version management of a project file for the program development.

However, in program development on a terminal device, the version management system implements many changes not reflected on the PLC, such as the setting of metadata and addition of test data, and points of changes in a program stored in the PLC do not correspond one-to-one to points of changes in the project file in the version management system. Additionally, when one PLC is connected with multiple terminal devices, each terminal device may have a point of change in the project file. Thus, a point of change in the program stored in the PLC cannot be easily determined based on a point of change in the project file in the version management system.

In response to the above circumstances, an objective of the present disclosure is to provide a programmable logic controller and associated techniques that can easily manage a point of change in a program stored in the programmable logic controller.

### Solution to Problem

To achieve the above objective, a programmable logic controller according to an aspect of the present disclosure includes program storage means for storing a program executable on the programmable logic controller, updating means for updating the program stored in the program storage means, and version managing means for performing version management of the program stored in the program storage means. The version managing means performs version management of the program stored in the program storage means based on a time at which the program is updated by the updating means and identification information for individually identifying the program to undergo version management.

### Advantageous Effects of Invention

The programmable logic controller according to the above aspect of the present disclosure can easily manage a point of change in a program stored in the programmable logic controller.

### BRIEF DESCRIPTION OF DRAWINGS

FIG. 1 is a diagram of a program management system according to Embodiment 1 of the present disclosure illustrating the overall configuration and is a functional block diagram of a programmable logic controller in the system;

FIG. 2 is a diagram of an example version management database in the programmable logic controller according to Embodiment 1 of the present disclosure;

FIG. 3 is a diagram of example logging data in the programmable logic controller according to Embodiment 1 of the present disclosure;

FIG. 4 is a functional block diagram of a terminal device according to Embodiment 1 of the present disclosure;

FIG. 5 is a diagram of the programmable logic controller and the terminal device according to Embodiment 1 of the present disclosure, illustrating an example hardware configuration;

FIG. 6 is a diagram illustrating a version management operation performed by the programmable logic controller according to Embodiment 1 of the present disclosure;

FIG. 7 is a diagram illustrating a logging operation performed by the programmable logic controller according to Embodiment 1 of the present disclosure;

FIG. 8 is a diagram illustrating a version management operation performed by a programmable logic controller according to Embodiment 2 of the present disclosure;

FIG. 9 is a diagram of a program management system according to Embodiment 3 of the present disclosure illustrating the overall configuration and is a functional block diagram of a programmable logic controller in the system; and

FIG. 10 is a diagram of an example version management database in a programmable logic controller according to a modification of the present disclosure.

### DESCRIPTION OF EMBODIMENTS

A program management system according to one or more embodiments of the present disclosure is described with reference to the drawings. In the figures, the same reference signs denote the same or equivalent components.

### Embodiment 1

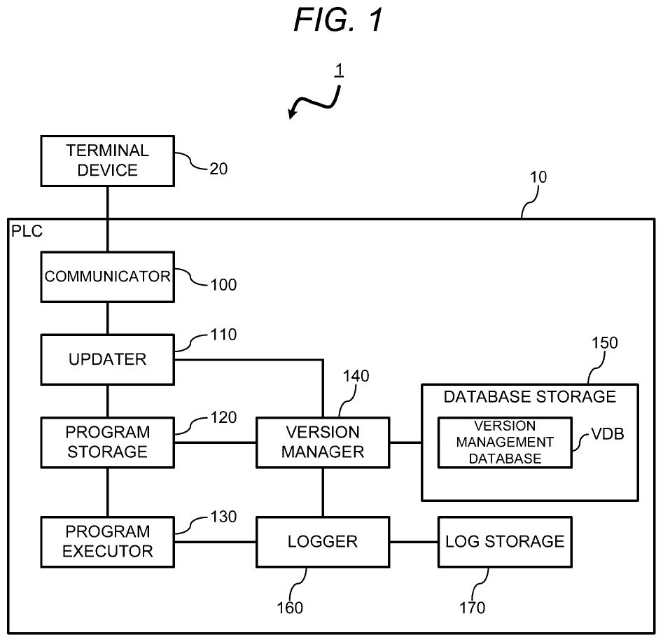

A program management system 1 according to Embodiment 1 is described with reference to FIG. 1. The program management system 1 includes a programmable logic controller (PLC) 10 and a terminal device 20. The PLC 10 is connected to the terminal device 20 to allow communication. The program management system 1 can easily manage the point of change in a program executable on the PLC 10 or a programmable logic controller. The program management system 1 is an example of a program management system in an aspect of the present disclosure.

The PLC 10 is a programmable logic controller that can execute a program developed with the terminal device 20. The PLC 10 may perform version management of programs executable on the PLC 10. The PLC 10 also records a log about the operation of the PLC 10. The PLC 10 is installed, for example, at a production site and controls field devices (not illustrated) such as a sensor and an actuator also installed at the production site. The functional components of the PLC 10 are described later. The PLC 10 is an example of a programmable logic controller in an aspect of the present disclosure.

In the PLC field, writing a program into a PLC includes writing a program developed as an executable file and also a readable program converted into the program developed as the executable file. The readable program is, for example, a program represented as a ladder diagram. A program in the present embodiment may thus include an executable file and also a readable program.

The terminal device 20 is used to develop a program executable on the PLC 10. The terminal device 20 is, for example, a personal computer in which a program provided as an engineering tool from the manufacturer of the PLC 10 is installed. The terminal device 20 may transmit a program executable on the PLC 10 to the PLC 10 to update the program executable on the PLC 10. The terminal device 20 may also display a log recorded on the PLC 10 together with the program executable on the PLC 10. The functional components of the terminal device 20 are described later. The terminal device 20 is an example of a terminal device in an aspect of the present disclosure.

The functional components of the PLC 10 are described below with reference to FIG. 1. The PLC 10 includes a communicator 100, an updater 110, a program storage 120, a program executor 130, a version manager 140, a database storage 150, a logger 160, and a log storage 170. The PLC 10 also includes typical functional components of a programmable logic controller in addition to the functional components illustrated in FIG. 1.

The communicator 100 communicates with the terminal device 20. The communicator 100 is, for example, implemented by a network interface. The communicator 100 specifically receives a program executable on the PLC 10 from the terminal device 20.

The updater 110 uses the program transmitted by the terminal device 20 and received by the communicator 100 to update a program stored in the program storage 120 (described later). The updater 110 is an example of updating means in an aspect of the present disclosure.

The program storage 120 stores a program executable by the program executor 130 (described later). The program stored in the program storage 120 is executable on the PLC 10. The program storage 120 is an example of program storage means in an aspect of the present disclosure.

The program executor 130 reads and executes the program stored in the program storage 120. The program executor 130 reads and executes the program stored in the program storage 120 to perform control of, for example, a field device (not illustrated).

The version manager 140 performs version management of programs stored in the program storage 120. More specifically, the version manager 140 sets, as a program to undergo version management, a program newly stored into the program storage 120 as a result of the updating by the updater 110. Thus, each time the program stored in the program storage 120 is updated by the updater 110, an additional program comes under version management. The version manager 140 is an example of version managing means in an aspect of the present disclosure.

The version management is described in detail. Upon updating by the updater 110, the version manager 140 assigns a version number to the program newly stored in the program storage 120. For example, version numbers may be assigned sequentially from 1, at random using, for example, a version-4 universally unique identifier (UUID), or using hash values acquired from programs used as binary data. The version numbers allow programs under version management to be uniquely identified. The version number is an example of identification information in an aspect of the present disclosure.

After the version number assignment, the version manager 140 associates the program newly stored in the program storage 120 with the version number and the updated time and registers the resultant data with a version management database VDB described later. This registration causes the program newly stored in the program storage 120 to undergo version management performed by the version manager 140.

The version manager 140 performs version management when, for example,
(1) notified by the updater 110 that the program stored in the program storage 120 is updated,
(2) the version manager 140 periodically checks the program storage 120 and detects updating of the program stored in the program storage 120, or
(3) notified of updating from the terminal device 20.
Each of these cases is described in detail below.

In (1), the updater 110 has the function of notifying the version manager 140 of a program update when the program stored in the program storage 120 is updated. The version manager 140 performs version management when notified from the updater 110.

In (2), the updater 110 has the function of storing a program updated time into the program storage 120 when the program is updated. The version manager 140 periodically checks the updated time stored in the program storage 120 and performs version management when detecting that the updated time is changed. With a typical file system such as NT File System (NTFS) or the fourth extended file system (ext4) built on the program storage 120, when the updater 110 updates a program, the updated time is also updated.

In some embodiments, the updater 110 has the function of storing a hash value acquired from a program used as binary data into the program storage 120 when the program is updated. The version manager 140 periodically checks the hash value stored in the program storage 120 and performs version management when detecting that the hash value is changed.

In (3), the terminal device 20 has the function of transmitting update notification of a program update to the PLC 10 when transmitting a program to the PLC 10. The version manager 140 monitors signals received by the communicator 100. The version manager 140 performs version management when detecting that the communicator 100 receives update notification from the terminal device 20.

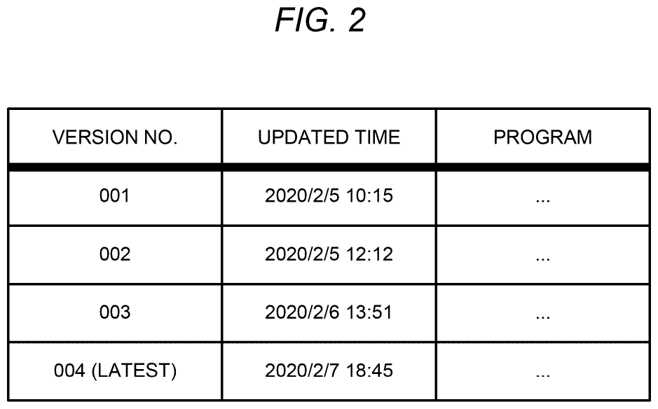

The database storage 150 stores the version management database VDB. The version management database VDB stores information about programs under the version management of the version manager 140. The version management database VDB is, for example, represented as a table illustrated in FIG. 2. In the example illustrated in FIG. 2, version numbers are assigned sequentially in chronological order starting with 001. The column PROGRAM indicates programs. More specifically, in FIG. 2, programs are registered with the version management database VDB in correspondence with the version numbers and updated times. Instead of the program registration with the version management database VDB, programs may be stored under the management of a typical file system, and the file names of the programs may be registered with the version management database VDB in correspondence with the version numbers and updated times.

The version manager 140 also outputs a signal indicating the version number of the program currently being executed by the program executor 130 to the logger 160 (described later). More specifically, the version manager 140 outputs a signal indicating the version number of the latest one of the programs under version management to the logger 160. The latest one of the programs under version management is the program currently stored in the program storage 120 and being executed by the program executor 130.

Referring back to FIG. 1, the logger 160 records an operating log for the operation of the PLC 10 into the log storage 170 (described later). More specifically, the logger 160 records the operating log into the log storage 170 together with the current time and the version number as logging data. The version number is the version number of the program currently being executed by the program executor 130. The current time is the recorded time at which the logging data is recorded. The logger 160 receives the signal indicating the version number of the program currently being executed by the program executor 130 from the version manager 140 to acquire the version number of the program currently being executed by the program executor 130. The logger 160 is an example of logging means in an aspect of the present disclosure.

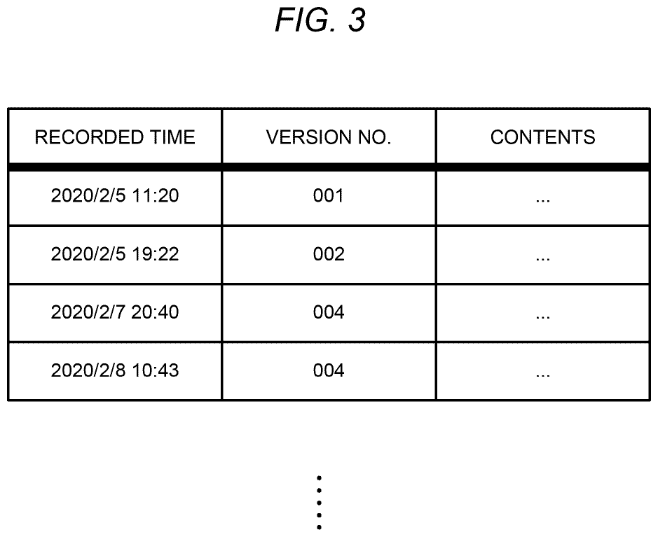

The log storage 170 stores the logging data recorded by the logger 160. The logging data is, for example, represented as a table illustrated in FIG. 3. In the example illustrated in FIG. 3, when, for example, the second log from the top indicates abnormality to undergo troubleshooting, a program having a version number before 002 (including program 002) has the cause of the abnormality. Thus, each program having a version number at or before 002 is to be analyzed selectively. The log storage 170 is an example of log storage means in an aspect of the present disclosure.

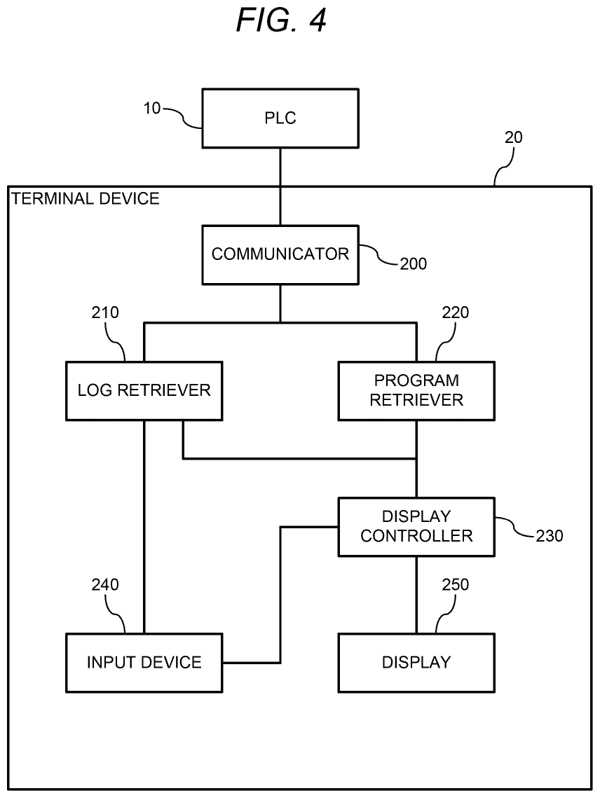

The functional components of the terminal device 20 are described below with reference to FIG. 4. The terminal device 20 includes a communicator 200, a log retriever 210, a program retriever 220, a display controller 230, an input device 240, and a display 250. The terminal device 20 also includes typical functional components for a user to develop a program executable on the PLC 10 in addition to the functional components illustrated in FIG. 4.

The communicator 200 communicates with the PLC 10. The communicator 200 is, for example, implemented by a network interface. The communicator 200 specifically receives logging data and a program from the PLC 10.

The log retriever 210 accesses the log storage 170 in the PLC 10 through the communicator 200 and retrieves logging data stored in the log storage 170 from the PLC 10. For example, the log retriever 210 retrieves logging data based on a user instruction provided through the input device 240 (described later). The log retriever 210 is an example of log retrieving means in an aspect of the present disclosure.

The program retriever 220 accesses the database storage 150 in the PLC 10 through the communicator 200 and retrieves a program registered with the version management database VDB from the PLC 10. More specifically, the program retriever 220 retrieves, from the version management database VDB, the program corresponding to the version number included in the logging data retrieved by the log retriever 210. In this manner, the program retriever 220 can selectively retrieve the program being executed on the PLC 10 when the logging data is recorded (in other words, the program stored in the program storage 120 in the PLC 10 when the logging data is recorded). The program retriever 220 is an example of program retrieving means in an aspect of the present disclosure.

The display controller 230 controls the display 250 (described later) to display the logging data retrieved by the log retriever 210 and the program retrieved by the program retriever 220 on the display 250. The display allows the user to review the details of the logging data and the details of the program corresponding to the logging data. The display controller 230 also controls the display 250 based on a user instruction provided through the input device 240 (described later). When, for example, the user performs an operation for changing the logging data displayed, the display controller 230 switches the display of the logging data and the corresponding program on the display 250. The display controller 230 is an example of display controlling means in an aspect of the present disclosure.

The input device 240 receives a user input and outputs a signal indicating the user input to the log retriever 210 and the display controller 230. The input device 240 is, for example, a keyboard, a mouse, or a touchscreen.

The display 250 displays the logging data and the program under the control of the display controller 230. The display 250 is, for example, a liquid crystal display. The display 250 is an example of display means in an aspect of the present disclosure.

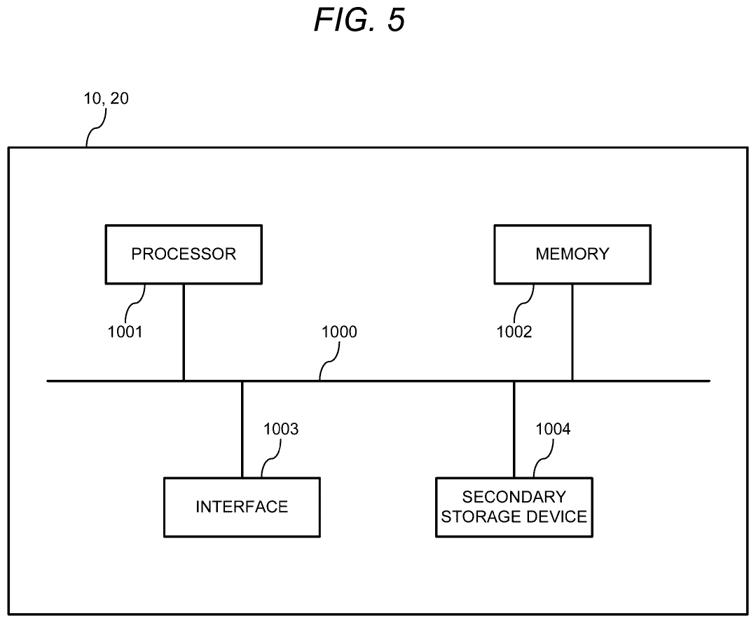

An example hardware configuration of the PLC 10 and the terminal device 20 is described with reference to FIG. 5. For the PLC 10, the configuration illustrated in FIG. 5 is implemented by, for example, a computer included in the programmable logic controller. For the terminal device 20, the configuration is implemented by a computer such as a personal computer, a smartphone, or a tablet terminal device.

The PLC 10 and the terminal device 20 each include a processor 1001, a memory 1002, an interface 1003, and a secondary storage device 1004 that are connected to one another with a bus 1000.

The processor 1001 is, for example, a central processing unit (CPU). The functions of the PLC 10 and the terminal device 20 are implemented by the processor 1001 that loads the operating program stored in the secondary storage device 1004 into the memory 1002 and executes the operating program.

The memory 1002 is a main memory device including, for example, a random-access memory (RAM). The memory 1002 stores the operating program loaded by the processor 1001 from the secondary storage device 1004. The memory 1002 serves as a work memory when the processor 1001 executes the operating program.

The interface 1003 is an input-output (I/O) interface, such as a serial port, a universal serial bus (USB) port, or a network interface. The interface 1003 implements the functions of the communicator 100 and the communicator 200.

The secondary storage device 1004 is, for example, a flash memory, a hard disk drive (HDD), or a solid-state drive (SSD). The secondary storage device 1004 stores the operating program to be executed by the processor 1001. The secondary storage device 1004 implements the functions of the program storage 120, the database storage 150, and the log storage 170.

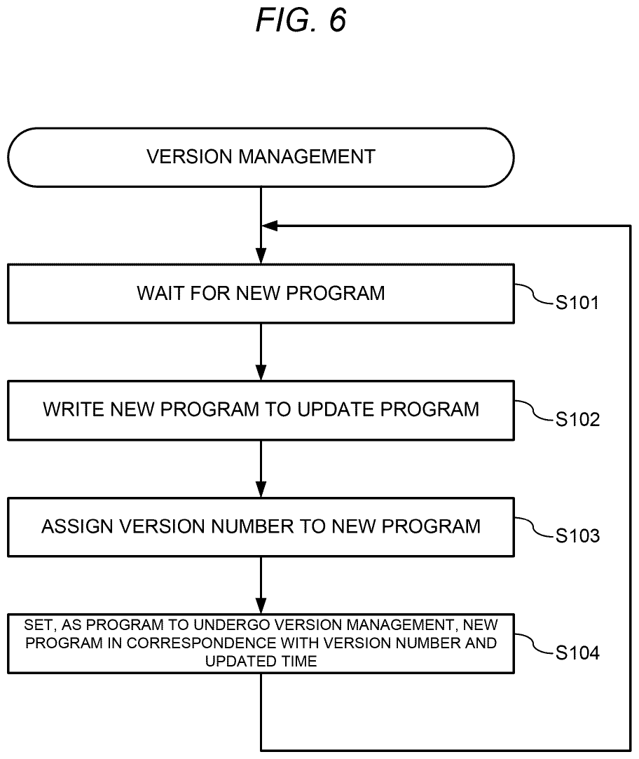

With reference to FIG. 6, a version management operation performed by the PLC 10 is described. The operation illustrated in FIG. 6 is started, for example, at the startup of the PLC 10.

The updater 110 in the PLC 10 waits for a new program transmitted from the terminal device 20 to the communicator 100 in the PLC 10 (step S101).

When the terminal device 20 transmits the new program, the updater 110 writes the new program received by the communicator 100 into the program storage 120 to update the program stored in the program storage 120 (step S102).

The version manager 140 in the PLC 10 assigns a version number to the new program updated by the updater 110 (step S103).

The version manager 140 sets, as a program to undergo version management, the new program by registering the new program in correspondence with the version number and updated time with the version management database VDB in the database storage 150 (step S104). The PLC 10 then repeats the operation in step S101 and subsequent steps.

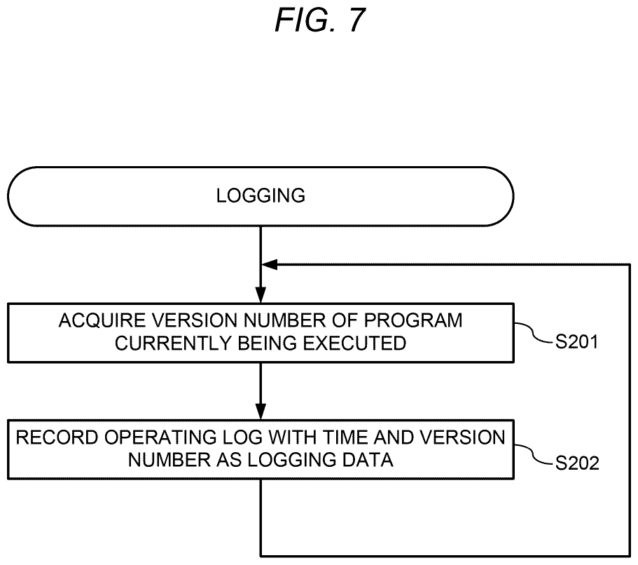

With reference to FIG. 7, a logging operation performed by the PLC 10 is now described. The operation illustrated in FIG. 7 is started, for example, at the startup of the PLC 10.

The logger 160 in the PLC 10 acquires the version number of the program currently being executed by the program executor 130 (step S201).

The logger 160 records the operating log of the PLC 10 into the log storage 170 together with the time and the version number acquired in step S201 as logging data (step S202). The logger 160 then repeats the operation in step S201 and subsequent steps.

In the program management system 1 according to Embodiment 1 described above, the PLC 10 performs version management of a program executable on the PLC 10. A program to undergo version management is added upon updating of the program executable on the PLC 10. Thus, the program executable on the PLC 10 has points of changes corresponding one-to-one to programs under the version management. This correspondence allows the user of the PLC 10 to easily manage the point of change in the program executable on the PLC 10.

### Modification of Embodiment 1

In Embodiment 1, the logger 160 in the PLC 10 records a log together with the time and version number, as also illustrated in FIG. 3. However, the logger 160 may record a log and a time without a version number. With logging data including no version number, as illustrated in FIG. 2, the updated time and the version are associated together, thus allowing identification of the version of the program being executed at the log recorded time.

### Embodiment 2

In Embodiment 1, the version manager 140 in the version manager 140 sets, as a program to undergo version management, the latest program currently stored in the program storage 120. However, the latest program currently stored in the program storage 120 is clearly the newest of the programs under the version management and thus may not be to undergo version management. In this case, when a program is updated, the program immediately before the updating is to be to undergo version management.

The PLC 10 in a program management system 1 according to Embodiment 2 does not set the latest program as a program to undergo version management as described above. The functional components are the same as those in Embodiment 1 illustrated in FIG. 1 and thus are not described, but differences in operation are described.

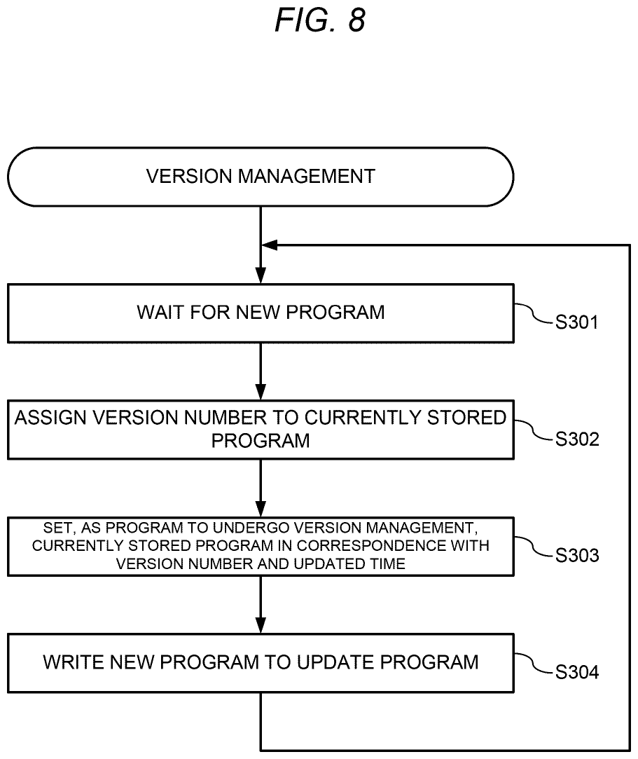

The version management operation performed by the PLC 10 is described below with reference to FIG. 8, focusing on differences from the operation in Embodiment 1 illustrated in FIG. 6.

Similarly to Embodiment 1, the updater 110 in the PLC 10 waits for a new program (step S301). This operation corresponds to step S101 in FIG. 6.

When a new program is transmitted, the version manager 140 in the PLC 10 assigns a version number to the program currently stored in the program storage 120 before the program is updated (step S302). This operation corresponds to step S103 in FIG. 6.

The version manager 140 sets, as a program to undergo version management, the program currently stored in the program storage 120 in correspondence with the version number assigned in step S302 and the updated time (step S303). This operation corresponds to step S104 in FIG. 6.

The updater 110 writes the new program into the program storage 120 to update the current program (step S304). This operation corresponds to step S102 in FIG. 6.

The PLC 10 then repeats the operation in step S301 and subsequent steps.

The PLC 10 according to Embodiment 2 may operate as described above to set, as a program to undergo version management, the program immediately before the updating, without setting a program newly stored as a result of the updating.

In Embodiment 2, logging data includes no version number similarly to the above modification of Embodiment 1. In Embodiment 2, the program currently stored in the program storage 120 has no assigned version number.

### Embodiment 3

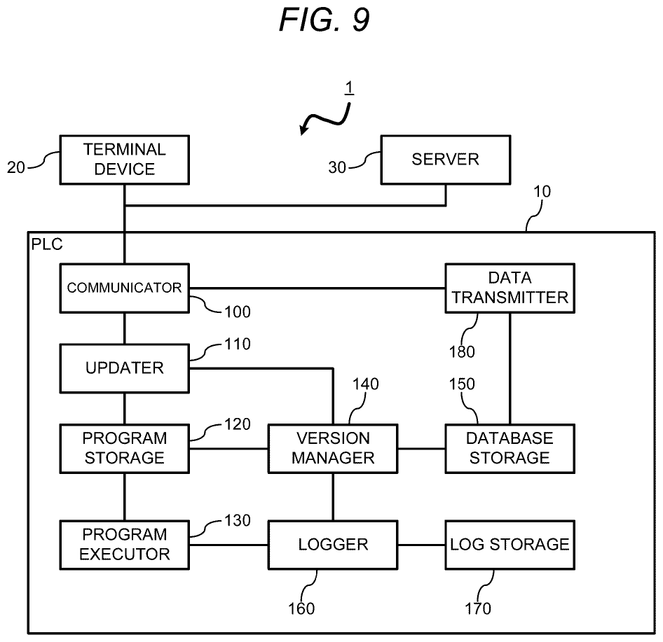

A program management system 1 according to Embodiment 3 is described with reference to FIG. 9. Unlike the configuration in Embodiment 1 illustrated in FIG. 1, the program management system 1 according to Embodiment 3 further includes a server 30 connected to the PLC 10 to allow communication, and the PLC 10 includes a data transmitter 180.

The server 30 is, for example, a typical file server. The server 30 stores logging data transmitted by the PLC 10 and the program corresponding to the logging data. The server 30 is an example of a server in an aspect of the present disclosure. The program corresponding to the logging data is the program stored in the program storage 120 when the logging data is recorded.

The data transmitter 180 in the PLC 10 transmits logging data recorded in the log storage 170 to the server through the communicator 100 together with the program corresponding to the logging data. The data transmitter 180 searches the version management database VDB in the database storage 150 and determines the program stored in the program storage 120 when the logging data is recorded, from among the programs under the version management of the version manager 140. The data transmitter 180 is an example of logging data transmitting means in an aspect of the present disclosure.

In the program management system 1 according to Embodiment 3, the PLC 10 transmits logging data to the server 30 together with the program corresponding to the logging data. The server 30 accumulates logging data and the programs corresponding to the logging data, and the data accumulated in the server 30 may be used for troubleshooting.

### Modification of Embodiment 3

In Embodiment 3, the data transmitter 180 in the PLC 10 transmits logging data and the program corresponding to the logging data to the server 30. Instead, when a new program to undergo version management is added, the data transmitter 180 may transmit the program to the server 30. The transmission allows the server 30 to store a backup of the program under the version management performed by the PLC 10. In this case, the server 30 may be a typical file server or a server on which a typical version management system operates. When the server 30 is a server on which a typical version management system operates, the PLC 10 operates as the client of the version management system. The data transmitter 180 in this modification is an example of program transmitting means in an aspect of the present disclosure.

### Other Modifications

In each of the above embodiments, a program undergoes version management in correspondence with the version number and the updated time. However, in addition to the version number and the updated time, a parent version that is the previous version of the program may also be associated.

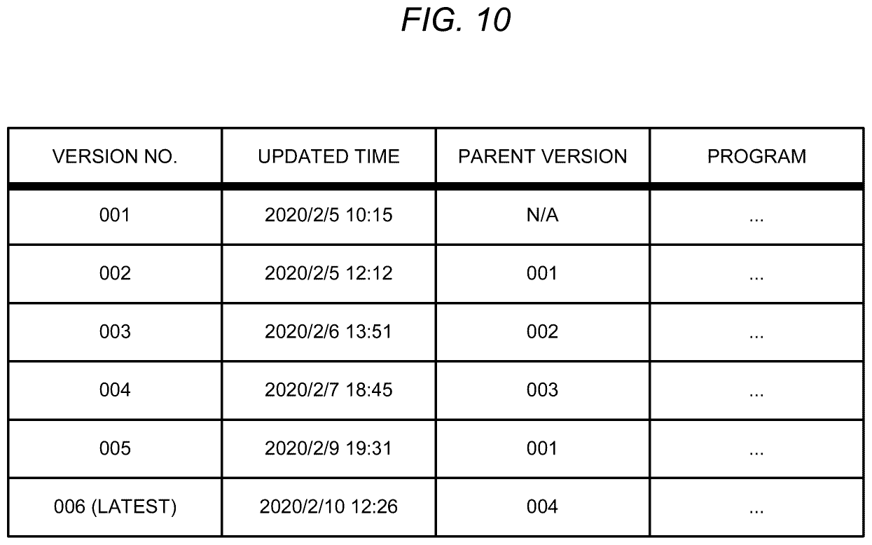

For example, as illustrated in FIG. 10, a version management database may contain information indicating the parent version of each version. In the example illustrated in FIG. 10, program 001 is the oldest program and has no parent version, and the parent version of program 002 is version 001. The parent version of program 005 is not version 004 but version 001, meaning that version 001 branches into two.

The parent version information indicates branches in the change history, thus allowing points of changes to be managed more specifically.

However, to manage data including parent versions, when correcting a program, the terminal device 20 is to identify the parent version and transmit the program to the PLC 10 together with information indicating the parent version. Programs are developed on the terminal device 20. The terminal device 20 is to identify the version of the previous program from which a new program is developed.

Thus, the user of the terminal device 20 is to first access the version management database VDB in the PLC 10 and acquire the previous program and the version number of the previous program.

In the hardware configuration illustrated in FIG. 5, the PLC 10 and the terminal device 20 each include the secondary storage device 1004. However, the secondary storage device 1004 may be external to the PLC 10 or the terminal device 20, and the PLC 10 or the terminal device 20 and the secondary storage device 1004 may be connected to each other with the interface 1003. In this configuration, the secondary storage device 1004 may be a removable medium such as a USB flash drive or a memory card.

In place of the hardware configuration illustrated in FIG. 5, the PLC 10 and the terminal device 20 may each have a dedicated circuit including an application-specific integrated circuit (ASIC) or a field-programmable gate array (FPGA). In the hardware configuration illustrated in FIG. 5, some functions of the PLC 10 and the terminal device 20 may be implemented by, for example, a dedicated circuit connected to the interface 1003.

The programs used in the PLC 10 and the terminal device 20 may be distributed on a non-transitory computer-readable recording medium such as a compact disc read-only memory (CD-ROM), a digital versatile disc (DVD), a USB flash drive, a memory card, or an HDD. A specific computer or a general-purpose computer on which the program is installed can function as the PLC 10 or the terminal device 20.

The programs may be stored in a storage in another server on the Internet and may be downloaded from the server.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### REFERENCE SIGNS LIST

1 Program management system
10 PLC
20 Terminal device
30 Server
100 Communicator
110 Updater
120 Program storage
130 Program executor
140 Version manager
150 Database storage
160 Logger
170 Log storage
180 Data transmitter
200 Communicator
210 Log retriever
220 Program retriever
230 Display controller
240 Input device
250 Display
1000 Bus
1001 Processor
1002 Memory
1003 Interface
1004 Secondary storage device
VDB Version management database

1. A programmable logic controller, comprising:
a program storage to store a program executable on the programmable logic controller; and
first circuitry to function as
an updater to update the program stored in the program storage, and
a version manager to perform version management of the program stored in the program storage, wherein
the version manager generates identification information for individually identifying a program to undergo version management, and performs version management of the program stored in the program storage based on a time at which the program is updated by the updater and the identification information.

2. The programmable logic controller according to claim 1, wherein
upon updating by the updater, the version manager sets, as a program to undergo version management, a program newly stored into the program storage as a result of the updating.

3. The programmable logic controller according to claim 1, wherein
upon updating by the updater, the version manager sets, as a program to undergo version management, the program stored in the program storage immediately before the updating, without setting a program newly stored into the program storage as a result of the updating.

4. The programmable logic controller according to claim 1, further comprising:
a log storage, wherein
the first circuitry further functions as
a logger to record, as logging data, a log about an operation of the programmable logic controller into the log storage together with a time.

5. The programmable logic controller according to claim 4, wherein
the logger records the logging data together with the identification information.

6. The programmable logic controller according to claim 4, wherein
the first circuitry further functions as
a logging data transmitter to transmit the logging data recorded in the log storage to a server, and
the logging data transmitter transmits the logging data together with a program stored in the program storage when the logging data is recorded, from among programs to undergo management by the version manager.

7. The programmable logic controller according to claim 1, wherein
the first circuitry further functions as
a program transmitter to, when the version manager sets a new program to undergo version management, transmit the new program to a server.

8. A terminal device, comprising:
second circuitry to function as
a log retriever to retrieve the logging data from the programmable logic controller according to claim 4,
a program retriever to, based on the logging data retrieved by the log retriever, retrieve, from the programmable logic controller, a program stored in the program storage when the logging data is recorded, from among programs to undergo management by the version manager, and
a display controller to cause a display to display the logging data retrieved by the log retriever and the program retrieved by the program retriever.

9. A program management system, comprising:
the programmable logic controller according to claim 4; and
a terminal device comprising second circuitry to function as
a log retriever to retrieve the logging data from the programmable logic controller,
a program retriever to, based on the logging data retrieved by the log retriever, retrieve, from the programmable logic controller, a program stored in the program storage when the logging data is recorded, from among programs to undergo management by the version manager, and
a display controller to cause a display to display the logging data retrieved by the log retriever and the program retrieved by the program retriever.

10. A program management method for managing a program to be executed on a programmable logic controller, the program management method comprising:
updating a program stored in a program storage to store the program executable on the programmable logic controller;
generating, by the programmable logic controller, identification information for individually identifying a program to undergo version management; and
performing version management of the program stored in the program storage based on a time at which the program is updated and the identification information.

11. A non-transitory computer-readable recording medium storing a program, the program causing a computer included in a programmable logic controller to function as
a program storage to store a program executable on the programmable logic controller,
an updater to update the program stored in the program storage, and
a version manager to perform version management of the program stored in the program storage, wherein
the version manager generates identification information for individually identifying a program to undergo version management, and performs version management of the program stored in the program storage based on a time at which the program is updated by the updater and the identification information.
